(19) United States
(12) Patent Application Publication
(10) Pub. No.: US 2016/0094132 A1
(43) Pub. Date: Mar. 31, 2016

(54) Optimum Offline Converter Control Using Intelligent Power Processing

(71) Applicant: Marco Antonio Davila, Tucson, AZ (US)

(72) Inventor: Marco Antonio Davila, Tucson, AZ (US)

(21) Appl. No.: 14/681,590

(22) Filed: Apr. 8, 2015

Related U.S. Application Data
(60) Provisional application No. 61/976,751, filed on Apr. 8, 2014.

(51) Int. Cl. H02M 3/335

(52) U.S. Cl. CPC H02M 3/33507

(57) ABSTRACT

Intelligent control methods are shown that increase efficiency and reduce standby power and start up power requirements

### RELATED APPLICATION/CLAIM OF PRIORITY

This application is related to and claims priority from U.S. provisional application Ser. No. 61/976,751, filed Apr. 8, 2014, and entitled Optimum Offline Converter Control Using Intelligent Power Processing, which provisional application is incorporated by reference herein.

1. Introduction

Presented in this application is a set of ideas aimed at increasing the performance of the offline Flyback converter. It addresses biasing, startup, feedback, and optimum control of the switch elements in the converter. Any one of the ideas can be applied to all converters in general. The introduction of digital control has allowed the power supply designer to add more complexity to the control with no or small penalties to the control circuitry. This presents a problem in describing each idea used since all the ideas are mostly packaged in firmware. This application tries to explain each of the ideas separately. The implementation of each idea does not have to be done with firmware and can be accomplished with circuitry, yet they are designed to be easily done with modern day micro controllers. The topology chosen was a flyback converter with synchronous rectification and with a primary resonance control switch as presented in U.S. non provisional application Ser. No. 14/274,598, filed May 9, 2014, entitled “Resonant Transition Controlled Flyback”, a copy of which is exhibit A hereto. Some ideas are restricted to this topology while others can be applied to all converters.

The efficiency of the unit is always a major consideration and now with more restrictive specifications at light load the efficiency at all load conditions is important. For light power consideration, what is needed is an efficient micro controller that can control a PWM. Unfortunately, when the micro controller has a PWM that controls the power supply it needs fine resolution to control the duty cycle which increases the frequency of the micro controller which increases power consumption. The solution is a hybrid solution in which the micro controller contains an analog PWM in which both analog components and the micro controller can control the PWM. The micro controller can then change operating conditions and modes while the analog circuitry maintains the fine resolution.

One of the most fundamental problems to solve in offline power supplies is getting the power supply to start. A power supply startup circuit main function is to charge a holding capacitor so that the control circuitry of the power supply is able to sustain itself during startup of the unit. With new standby power standards, reduction in standby power requirements has been added to the startup circuit. This implies that the startup circuit has to be able to be used only when starting up and not all the time. It also needs to be efficient at getting the energy in the first place because it is becoming the main energy source in standby power since the main power train is not running during this mode. Another added requirement is of measuring the AC line. If the standby circuit is able to measure the line and the line is not in the correct range it should not draw any power. Measuring the line itself also consumes power using divider networks, so a more efficient method of measurement is also needed. Another source of power consumption is the safety requirement to discharge the commonly used X-capacitor that is across the AC line to safe voltage levels in the allotted time. Usually a resistor accomplishes this task which further increases the standby power.

### SUMMARY OF THE PRESENT INVENTION

Presented in this patent application is a new method that addresses all the standby power functions with a substantial reduction of power. Why is standby power so important? The answer would surprise you. It has to do with how people use power supplies normally. Most people do not unplug their chargers. Because of the time ratio between a charge cycle and a full day, the standby power is a very large portion of the power used. Therefore, the majority of power used by the charger is not in charging the target device but in standby power. Reducing this power increases the effective efficiency of the device over a 24 hour period. This startup circuitry will accomplish startup, biasing, line measurement, and X-cap discharge.

The second circuitry presented will be the drive control method for the synchronous rectifier, main switch, and winding shorting switch. In this particular implementation there is a winding shorting switch that shorts the primary winding to conserve the ringing energy to be used at the right time. This method is presented in U.S. non provisional application Ser. No. 14/274,598, exhibit A hereto. The synchronous rectifier control is independent of this method. The synchronous rectifier is turned on not only when there is current flowing through it in a normal direction; it also is controlled such that there is some reverse current in some situations. This is done to reduce turn on losses on the main switch. The amount of reverse current (also called push back current) is optimized so that only the most efficient amount is used depending on line conditions. The reason for this is that if more push back current is used more power has to be delivered to the transformer in the on state. The optimization finds the best compromise based on a particular unit and situation.

Thus, the present invention provides several new and useful concepts for a converter, particularly an offline converter.

One of the new and useful concepts comprises a power supply circuit portion that produces a bias voltage, where the power supply circuit portion has a switch network configured to draw and rectify power from an A/C power supply at levels close to the bias voltage produced. In a preferred version of this concept, the switch network is configured to synchronize to the line voltage of the circuit, by using valley exits measured in the line voltage. Also, in a preferred version, the circuit is configured to measure the slope of the input voltage line close to zero crossing to determine the amplitude of the input line voltage. Moreover, in yet another preferred version, the circuit is configured to regulate the bias levels by changing the amount of time the power supply circuit portion is on.

In another of the new and useful concepts, a power supply circuit portion for a converter has a synchronized rectifier in the output of the circuit, where the voltage across the winding that is attached to the synchronized rectifier is integrated in time during the on time of the primary switch and during the on time of the synchronized rectifier so that when the integral crosses zero determines when the synchronized rectifier turns off. In this concept, the threshold of the integral is modified from zero to a controlled negative value. Also, the power supply circuit can be configured to measure the voltage across the winding that is attached to the synchronized rectifier where the drain waveform is used with a blocking capacitor to reproduce the differential voltage across the winding. Moreover, an additional winding is used instead of the synchronous rectifier winding to measure the integral.

In yet another new and useful concept of the present invention, a power supply circuit portion comprises a discontinuous mode flyback converter where peak current limit is used in the primary and the output current limit is controlled by varying the frequency of the flyback based on the output voltage or another winding that reflects the output voltage setting.

These and other features of the present invention will become further apparent from the following detailed description and the accompanying drawings.

### BRIEF DESCRIPTION OF THE DRAWINGS

FIGS. 1 and 2 are schematic illustrations of prior art circuits;

FIG. 3 is a schematic illustration of a power supply circuit portion, in accordance with one embodiment of the present invention;

FIGS. 4-8 show waveform, voltage levels, frequency, bias, synchronization, and measurement data for the power supply circuit portion of FIG. 3;

FIG. 9 shows a prior art concept for synchronous rectification of a flyback;

FIG. 10 shows waveform, voltsec, magnetizing current and other synchronization data for rectification according to the present invention;

FIG. 11 shows a circuit portion providing synchronous rectification in accordance with the principles of the present invention;

FIG. 12 shows an implementation of a volt-second control circuit, in accordance with the principles of the present invention; and

FIG. 13 shows a flyback circuit portion with constant current limit control, in accordance with the principles of the present invention.

### DETAILED DESCRIPTION

### 2.1 Prior Art for Bias Startup and Line Sensing

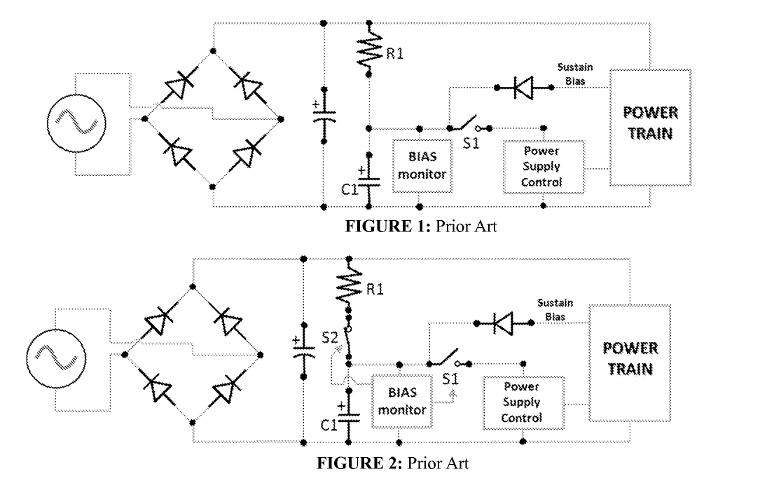

Shown in FIG. 1 is the normal way startup bias is achieved. R1 charges a capacitor C1 and the control circuit IC1 detects when the capacitor voltage is large enough to sustain the bias and turns on switch S1 to the rest of the power supply control circuitry. Normally the voltage turn on threshold is above the turn off threshold so that the difference in voltages provides enough charge to sustain the startup requirements. The charging resistor continues to dissipate power and the voltage monitoring portion of the control circuitry needs some minimum power. An improvement to the circuit is shown in FIG. 2 that disconnects the resistor when the switch S1 is turned on so that the resistor does not continue to dissipate power. Changing switch S2 into a regulator improves the circuit further into not requiring the large capacitor value and eliminates switch S1. Still the power required for the bias circuit is coming from the rectified line so the circuit is not efficient because the power dissipated is proportional to the peak of line and the bias current needed. Normally the line peak is around 170V in the US and as high as 340V in Europe, yet less than 20V is needed for the bias.

### 2.2 Improved Bias Startup and More

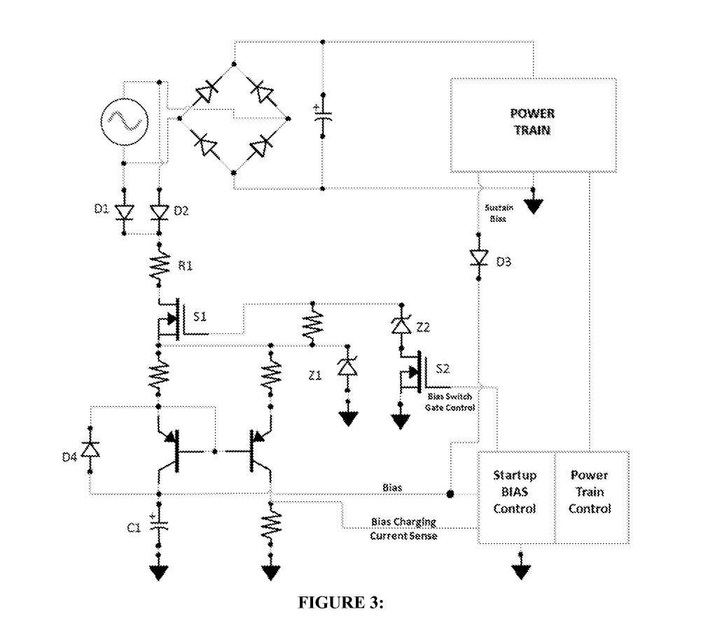

In order to reduce the power further the bias is taken before the main bridge with extra diodes as shown in a particular implementation of the new idea shown in FIG. 3. If bias is taken continually this would reduce the power by using the voltage from the line before rectification so that the RMS voltage is reduced from the peak of the line to the RMS of the line. For example, at 120 Vac input, the peak is 162 Volts and the bulk capacitor after the bridge is charged to this peak, therefore the dissipation on a biasing circuitry would be based on 162 volts. If instead the bias circuitry takes the power before the main bridge the RMS of the input line would be the new voltage which is 120V. The dissipation would be reduced by a factor of 2. But this can be improved even further.

In order to draw power from the line more efficiently, the line has to be at voltage closer to the bias voltage needed. Measurement of the line is still needed in order to synchronize with low line voltages, but how to measure the line efficiently. The circuitry shown in FIG. 3 accomplishes both. The implementation of the switch is done with a depletion mode MOSFET. A depletion mode switch is needed in this implementation in order for the controller to receive power while it is initially unpowered. This is automatically clamped by zener diode Z1. Once the controller is biased it starts controlling the switch and measures the current into the bias.

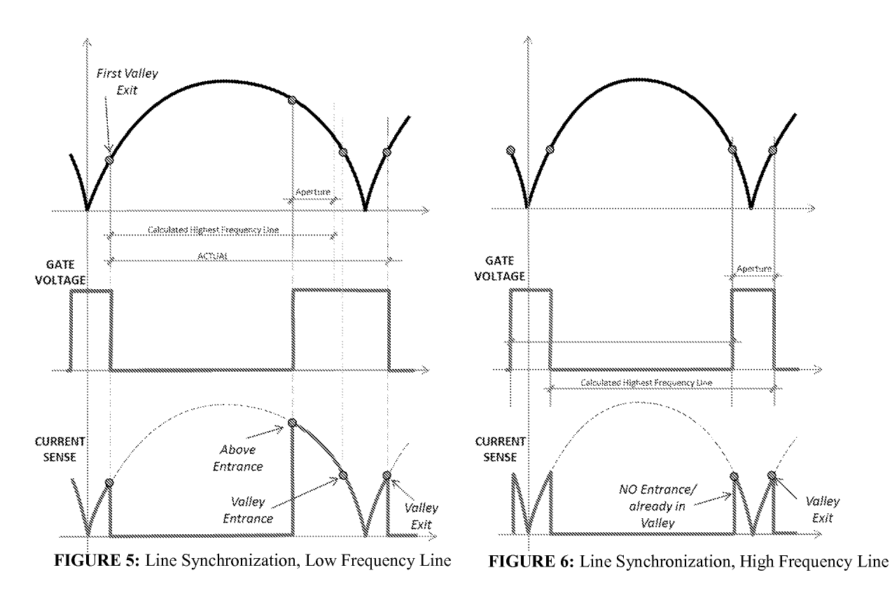

By measuring the amount of bias charging current the line amplitude can be determined with the same high voltage bias switch. The amount of current is proportional to the difference in line voltage and bias voltage. The controller shown has an algorithm that searches for the line valleys (rectified line close to zero crossing produces valley shaped voltage waveforms, see FIG. 5). By turning on and off the switch (S1), synchronization of the line can be accomplished. The algorithm can be broken down into 3 discrete states for line detection. The first state is the search for a valley, the second state is line synchronization, and the third state is line measurement. In all the states bias needs to be maintained but it is maintained differently in each state as the controller learns the input line.

In the first state the controller does not know the line frequency, voltage, and is not synchronized to the line. It creates a periodic search pattern that turns on and off the switch for defined times and searches for a valley. While the switch is on, a valley is detected when the charging current is below a certain level determined by the charging resistors and designed bias voltage. At the same time bias has to be maintained on the controller. This is accomplished with hysteretic control of the same switch. If the bias is below the low threshold it overrides the periodic pattern by turning on the gate until the bias is inside the normal window. While the switch is on the controller takes advantage of this situation and measures for the valley since the gate is on anyway. If the bias is too high the period pattern is again overridden and the switch is held off until the bias is within the normal limits. In this case, current measurements are suspended since the current is zero in this situation. A valley is detected by having a low charge current while the switch is on. When detected, the state is changed to the line synchronization state. FIG. 5 shows waveforms depicting the switch gate control search pattern with bias voltage waveform. Note that the gate waveform is for switch S1, switch S2 gate is inverted compared to this waveform, for example an on of switch S1 is an off of switch S2. The gate of switch S1 moves between bias and a defined low voltage by zener diode Z2. This voltage is used for standby mode to control a minimum voltage when the controller is off and low power mode.

In the synchronization state, once a valley is detected the switch is held on until a valley exit is detected. On valley exit a timer is started and the switch is turned off. A valley exit occurs when the current increases past a defined threshold. This threshold will be re-used as the detection method for all valley exits. During this “forced on” the bias will increase but not at a large rate since the charging resistors are designed for this current threshold. The charging resistors are designed so that they maintain the bias correctly at low line conditions with a turn on time close to the valley entrance to exit. If the bias is not in the correct range the state is changed back to the valley search state. The time from switch on to valley exit is controlled by the bias regulation algorithm and is referred in this application as the aperture time. The initial value of this aperture is used in the calculation to determine when the timer expires. Since the frequency of the line is not known yet. The line frequency could be either 50 or 60 Hz or even higher with tolerances for frequency. Assuming the worst case fastest frequency, the next valley exit from the previous can be calculated to be 1/(2*Fhighest). The controller then takes this value minus the starting aperture and sets this as the timer end. When the timer matches this time the switch is turned back on (the timer continues counting). The controller starts again to measure for a valley exit knowing that it could have turned on either in the valley or slightly earlier of the valley entrance (in case of lower frequency line). If a high current measurement is immediately made then the turn on was early of the valley entrance (see FIGS. 5 and 6 for the two possible line frequency scenarios). The controller will then wait for a valley entrance before going further. In either case, once in the valley it waits for a for a valley exit. On a valley exit the controller then checks the timer. This value is the time from the last valley exit to this valley exit and is half the period of the line frequency. With this time the controller now knows the line frequency. Again the switch is turned off at valley exit. The controller now calculates the next turn on time based on the fixed aperture time and the newly acquired half period time. The timer is reset to zero (or a time stamp is recorded) and continues counting. The state is now changed to line measurement.

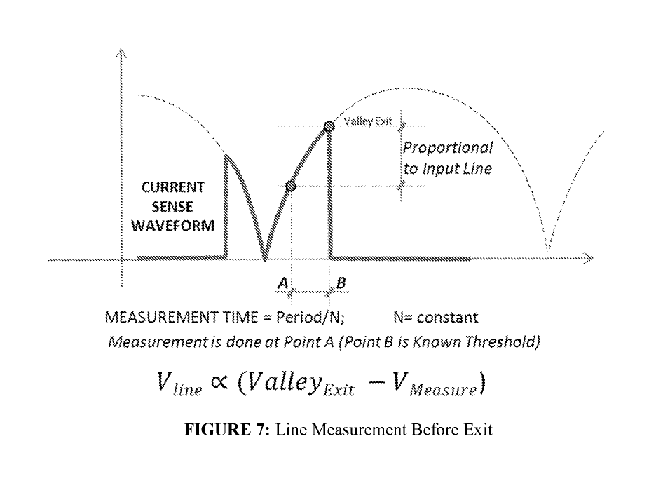

Since the switch is only on during valleys the line amplitude cannot be measured by the current amplitude. The only available parameter that can be used for line measurement is the slope of the current which is proportional to the line voltage. Unfortunately it is also proportional to the line frequency. Since the line period is known, if a time difference that is proportional to the line period is used, it normalizes the movement in the line. The valley exit is at a fixed time and voltage threshold, a measurement can be done a calculated time before the exit time. This is shown in FIG. 7. The difference between this measured voltage and the valley exit threshold is proportional to line voltage and is quite accurate. What is not accurate is the timing which has discrete resolution. Therefore this measurement is averaged over several half cycles to compare to the correct input line voltage for the power supply. During this averaging this state continues to measure the line period synchronizing on each exit. It may take several cycles to accurately measure the line and during this time the aperture for the bias is slowly regulated. This is done with a slow PID (proportional, integral, differential) loop. This loop measures the bias at the same rate as the half period and slow corrects the initial aperture regulating the bias voltage.

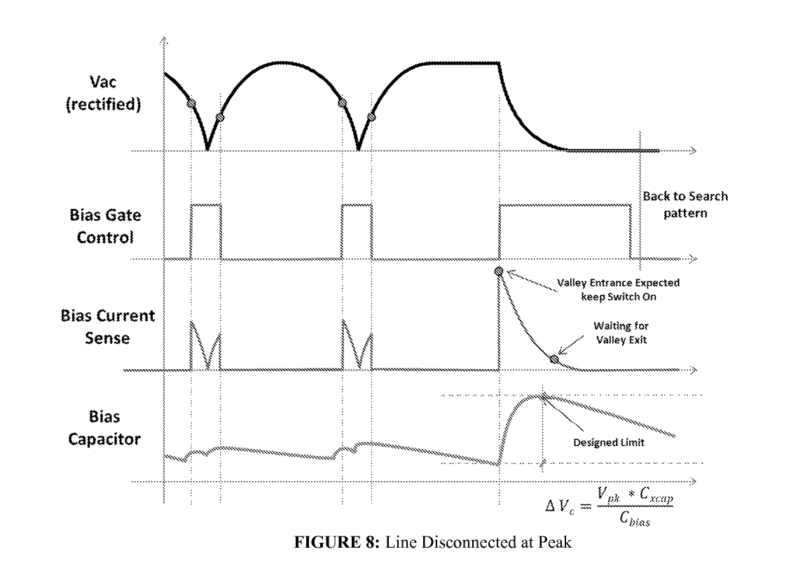

The X-Capacitor discharge is automatically taken care of in this algorithm. If the unit is disconnected from the line during the non-valley portion (shown in FIG. 8), at the next calculated “on” the voltage will be high, but since the controller would detect a large current it will assume it is to the left of a valley entrance which would keep the switch on until a valley exit. Therefore, the x-capacitor is quickly discharged by the bias resistors. The charge of the x-capacitor is then stored in the bias capacitor. The bias capacitor can be sized correctly so that the bias voltage changes a few volts. If the unit is disconnected during a valley the voltage is already low which also complies with safety. The switch will remain on anyway because the controller would be still waiting for a valley exit, again discharging the x-capacitor further.

Once a good line is detected the controller can go signal the unit to run. If the same controller is used to run the power supply this signaling is done internally. After the power supply is switching, the biasing algorithm can be modified 4 different ways to reduce power consumption further. The first way is no modification at all, leave the algorithm detecting the line and biasing the control. While running the controller will require more power but this extra power will come from the power train. The second modification would be that the aperture would be reduced just enough to still do the line measurement but not regulate the bias anymore since the bias could be supported from the power train. The third modification is reduce the aperture even further keeping line synchronization but stop measuring the line, while the unit is running the line can be measured in other ways for example from bulk voltage reading. Line synchronization still retains the x-capacitor discharge function. The fourth modification would be to completely stop the algorithm. The x-capacitor function would be lost but if the unit is a power factor correction unit or can discharge the bulk capacitor with the power train this maybe a viable option other than adding back an x-capacitor discharge resistor.

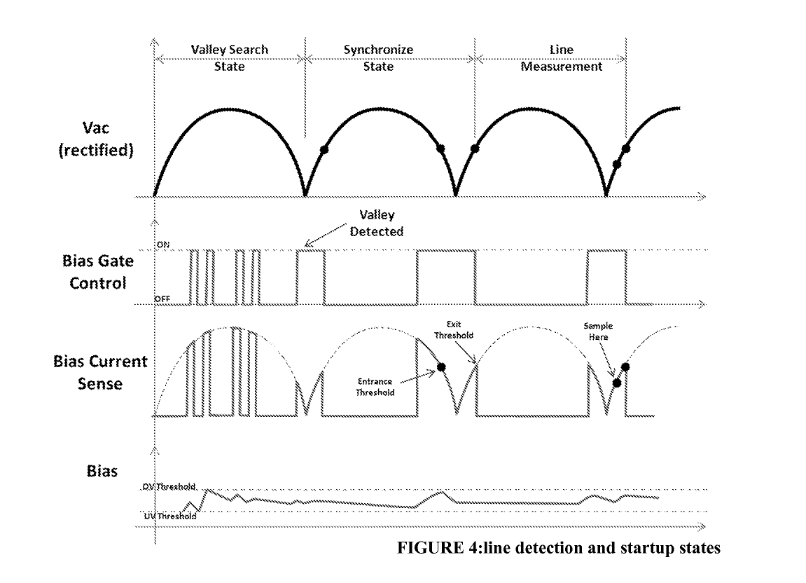

In standby power mode (if the power supply needs one), the controller consumes very little power by going to sleep. When in this mode the controller can either completely stop the algorithm and set the switch to off and regulate at very low level shown by the lower Zener diode (D3) voltage value shown in FIG. 4 by using the ability of the depletion mode MOSFET to regulate, or the controller can go into a periodic wake up to keep line synchronization alive. Either way, the power consumption is low. X-Capacitor discharge in standby mode is accomplished either by having enough bias consumption while in sleep mode, or by the periodic wake to keep line synchronization alive.

### 3.1 Prior Art for Synchronized Rectifier Control for Flyback Converter

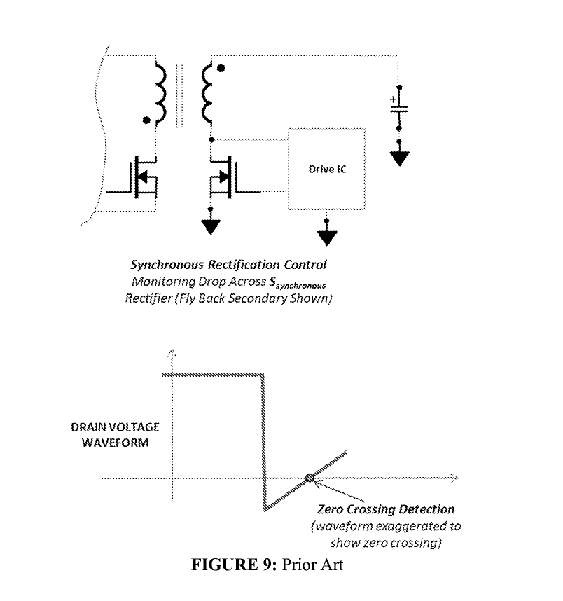

Synchronized rectification on a flyback has been controlled by measuring the current in the switching device to simulate an ideal diode function. This is done either by measuring the current directly with a current transformer, a shunt resistor, or by the drop of the switch itself. Shown in FIG. 9, is a particular implementation using a MOSFET with a control IC that detects the drop across the MOSFET. By using the drop across the MOSFET, no extra current sense circuitry is needed. But as switching devices improve, the drop across the switching device becomes lower and lower making it more difficult to determine the correct turn off. Worst yet the low turn off threshold becomes susceptible to noise which causes unpredictable turn off timing. This starts to cause the switch to turn off early. This causes more dissipation since the drop across the switch increases to the body diode drop which is normally larger than the channel drop. In addition, a small amount or reverse current maybe needed to improve the efficiency at high line. What is needed is an accurate method of controlling the synchronous rectifiers that will not be dependent on the drop of the switch and does not add additional current measurement circuitry.

### 3.2 Synchronized Rectifier Control by Volt Second Ramp

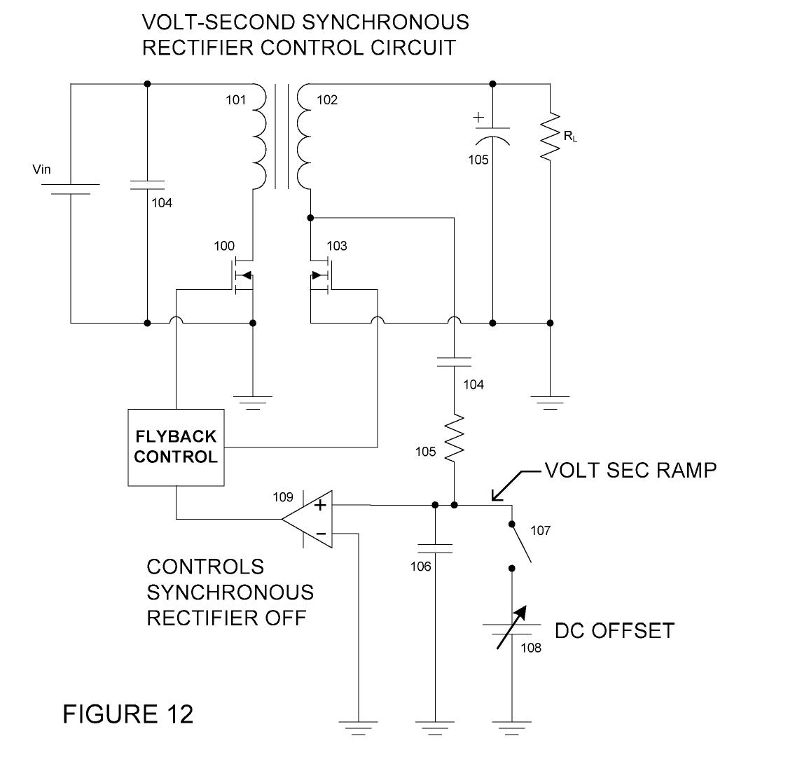

Shown in FIG. 12 is a particular implementation of a volt-second control circuit. The idea of volt-second control circuit is that the amount of volt-seconds during the primary on time is recorded by some means, then the same volt-seconds is used as a threshold to control the synchronous rectifier. Volt-second measurement in this case is the integral of the winding voltage over time. In all magnetics this value is always equal to zero to maintain steady state equilibrium. Decreasing the amount of the threshold will produce a slight reverse or push back current if used to turn on the synchronous rectifier. Increasing the volt-second threshold will produce a signal that is slightly less than is needed in case the circuit needs a synchronous rectifier turn off before zero current.

The circuit shown in FIG. 11 records the volt-seconds by using the winding voltage to charge capacitor 106. The amount of current in resistor 105 is proportional to the voltage in the winding while the time is the same, therefore current-time or charge in the capacitor represents the voltage-time. The capacitor 104 is a very large value to block the DC output voltage; therefore the differential voltage of the winding 102 appears on resistor 105. When the primary switch 100 turns off, the winding reverses polarity which reverses the current flow in the circuit which starts discharging the capacitor. The synchronous rectifier 103 is turned on at the moment when the primary switch turns off. When the voltage on the capacitor 106 returns to the original starting voltage the volt-seconds during the reset matches the volt-seconds during the primary switch turn on and the synchronous rectifier can be turned off at this point. This is accomplished in the circuit of FIG. 12 by comparator 109. This comparator signals the flyback controller the time to turn off the synchronous rectifier by a falling edge.

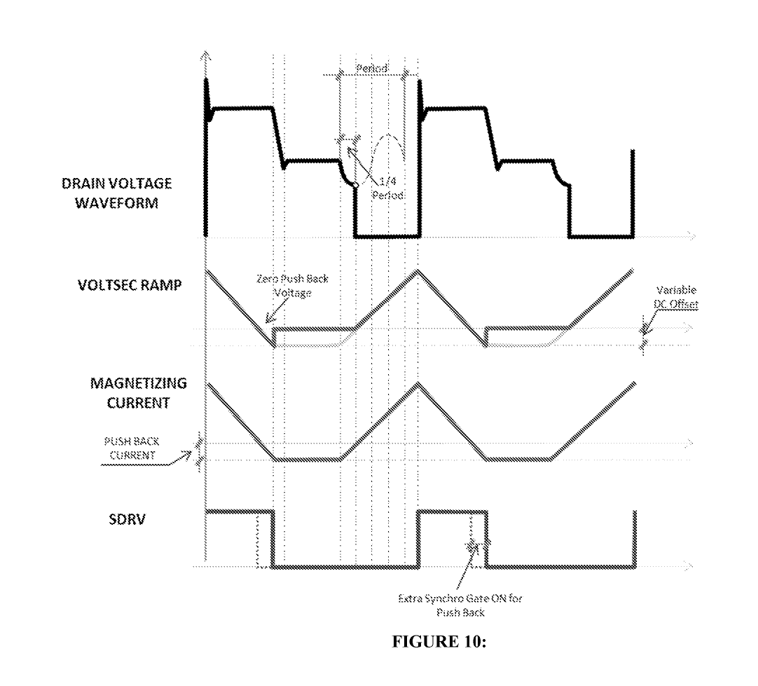

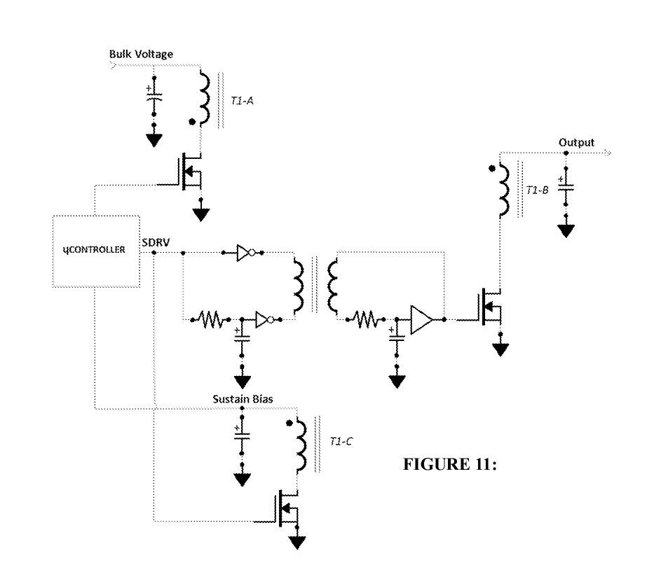

Due to the fact that the current in the resistor 105 is not exactly proportional to the winding voltage but to the difference between the winding voltage and the capacitor 106 voltage some imperfections arise. If the circuit is done with perfect voltage to current conversion using a current mirror or other circuit the ramp will precisely represent the volt-seconds in the transformer. Another way to keep this simple RC circuit but retain accuracy is by either having a low ramp voltage compared to the winding voltage or by centering the RC circuit around a zero DC voltage average by letting the RC circuit “float”. The second solution has problems in that the circuit needs to define a starting zero. In fact, this is a general problem for the circuit. This is a similar problem in trying to find a residual magnetic flux in the transformer. The shorting circuit 107 connected to the capacitor 106 is designed to solve this problem. When the synchronous rectifier turns off and the primary switch has not turned on yet, the capacitor circuit is held at a known DC level 108. The DC level is defined as the zero level for the flux even though the transformer may have some residual flux, this is corrected later. The correction occurs during the near ZVS transition shown in FIG. 10 at the ¼ wave primary switch 100 turn on point. The portion of time between the synchronous rectifier 103 off to primary switch 100 turn on is referred in this document as the discontinuous time. Right before the primary switch will turn on; the winding shorting switch of the flyback converter is released. This starts a resonant transition where the stored energy in the transformer is used to resonate the voltage on the primary switch towards zero. Depending on the energy the end voltage will change but the time remains the same due to the time constant of the magnetizing inductance of the transformer and the parasitic capacitance elements in the power train circuit. If the primary switch did not turn on, this voltage would ring at a fixed frequency and period (shown as the dashed waveform for the drain voltage waveform in FIG. 10). The primary switch is designed to turn on at exactly one quarter of this period to take advantage of the lowest voltage to reduce turn on losses (see FIG. 10). At this lowest voltage, the energy in the transformer is zero, therefore at this exact moment the ramp circuit is released. This equates the voltage on the ramp to the zero current level in the transformer since at the bottom the ¼ wave ring the current in the transformer is zero.

If the synchronous rectifier turn off ramp threshold is reduced below the zero mark a controlled amount of push back current is programmed. In order to not use negative voltages an alternative method was used in that the circuit does not zero the ramp to a zero voltage during the discontinuous time but sets it to a controlled DC voltage 108. The threshold to turn off the synchronous rectifier remains at zero. The DC level is changed by the microcontroller with resistors or with a DAC. But other methods exist that can control the DC starting voltage which can control the push back current like using a PWM. In this way, the controller can increase or decrease the amount of push back current needed depending on line and load conditions.

By changing the amount of this threshold different amounts of push back currents can be programmed. At high input voltage the amount of turn on losses is greater. By increasing the amount of push back current at this high input voltage conditions the amount of turn on losses be reduced. Why not increase them for all line conditions? The energy for push back comes from the output of the power supply. The power supply would have to increase the output power in order to replace this energy. Increasing the output power increases the amount of forward current. In fact the amount of forward current peak change is equal to the push back current peak. A compromise is where the lowest losses occur. This optimum point changes with line, load, and the components of the power supply. These optimum points could be measured and designed into the controller. The controller used in this implementation knows the line and load and has tables stored in it that programs the optimum conditions. The tables were originally stored during the design stage of the power supply. If the same controller would be used in a different power supply design it would have a different set of tables.

Due to the particular nature of the flyback described in U.S. non provisional application Ser. No. 14/274,598, exhibit A hereto, the tables in addition to the push back threshold also encode the optimum frequency and peak current threshold for a particular load and line. But this could be done with any discontinuous mode flyback

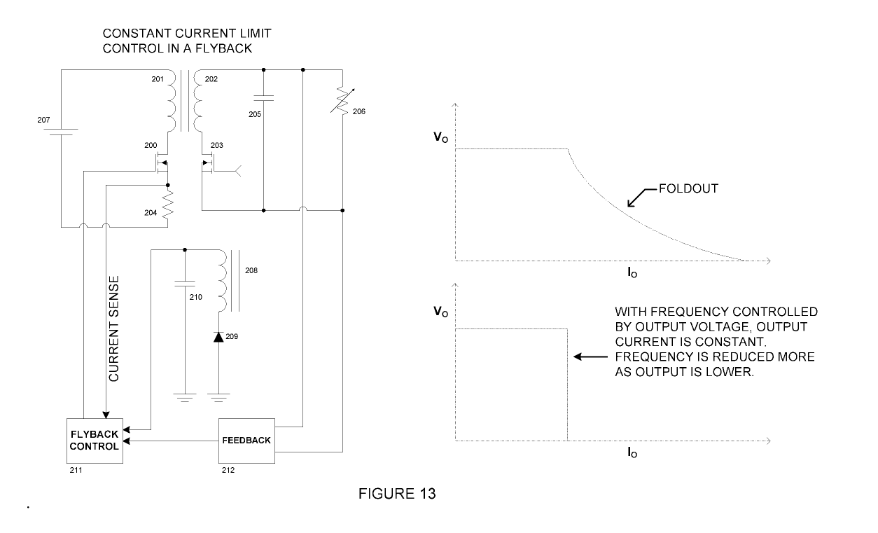

Since tables can be a very powerful tool, there are other ideas that were implemented with them. A separate table was designed so that as the output voltage is measured then the current limit point of the converter is modified. The natural output current limit characteristic of a peak primary current mode controlled flyback folds out as the output voltage is lowered. This is shown in FIG. 13. In additional, since the reset time of the transformer is proportional to the output voltage a discontinuous mode flyback will become continuous. This causes reverse recovery losses and cross conduction on the primary switch. If the period of the frequency is increased to compensate for the current fold out phenomenon, it will not only control the current limit it will also prevent the continuous mode phenomenon. This also solves the voltage spikes and other stresses during startup. The controller has this additional table that modifies the switching frequency when the output is reduced. The lower the output voltage the lower the frequency. This period/frequency adjustment protects the power supply from continuous mode and controls the output current without the need for a secondary side current limit or shunt.

Feedback on a power supply is sometimes done with an opto-coupler. They are simple to use but over time their performance degrades. If not designed correctly the opto-regulator would lose control of a power supply causing a under voltage or even worst and over voltage condition. Winding feedback is more difficult to use in the past. But due to synchronized rectification the output voltage is more accurately represented without peak charging. The synchronized rectifier in this implementation is independent of load and it also turns on and off correctly with light loads. This allows winding feedback to be used. In order to be used correctly both the output winding and the feedback winding must have synchronized rectifiers. Shown in FIG. 11, a drive transformer is used to transfer the signal from the controller to the secondary synchronous rectifier. The same signal is used to drive the winding feedback (also used for bias synchronous rectifier. Because there are still drop differences between the winding feedback and the real output, regulation is still not optimum. Using still another table the controller adjusts its internal regulation reference to compensate for these drop differences which maintains accurate output regulation without the need of an opto-coupler.

Thus, the present invention provides several new and useful concepts for a converter, particularly an offline converter.

One of the new and useful concepts comprises a power supply circuit portion that produces a bias voltage, where the power supply circuit portion has a switch network configured to draw and rectify power from an A/C power supply at levels close to the bias voltage produced. In a preferred version of this concept, the switch network is configured to synchronize to the line voltage of the circuit, by using valley exits measured in the line voltage. Also, in a preferred version, the circuit is configured to measure the slope of the input voltage line close to zero crossing to determine the amplitude of the input line voltage. Moreover, in yet another preferred version, the circuit is configured to regulate the bias levels by changing the amount of time the power supply circuit portion is on.

In another of the new and useful concepts, a power supply circuit portion for a converter has a synchronized rectifier in the output of the circuit, where the voltage across the winding that is attached to the synchronized rectifier is integrated in time during the on time of the primary switch and during the on time of the synchronized rectifier so that when the integral crosses zero determines when the synchronized rectifier turns off. In this concept, the threshold of the integral is modified from zero to a controlled negative value. Also, the power supply circuit can be configured to measure the voltage across the winding that is attached to the synchronized rectifier where the drain waveform is used with a blocking capacitor to reproduce the differential voltage across the winding. Moreover, an additional winding is used instead of the synchronous rectifier winding to measure the integral.

In yet another new and useful concept of the present invention, a power supply circuit portion comprises a discontinuous mode flyback converter where peak current limit is used in the primary and the output current limit is controlled by varying the frequency of the flyback based on the output voltage or another winding that reflects the output voltage setting.

1. A power supply circuit portion that produces a bias voltage, the power supply circuit portion having a switch network configured to draw and rectify power from an A/C power supply at levels close to the bias voltage produced.

2. The power supply circuit portion of claim 1, wherein the switch network is configured to synchronize to the line voltage of the circuit, by using valley exits measured in the line voltage.

3. The power supply circuit portion of claim 1 that is also configured to measure the slope of the input voltage line close to zero crossing to determine the amplitude of the input line voltage.

4. The power supply circuit portion of claim 1 that is also configured to regulate the bias levels by changing the amount of time the power supply circuit portion of claim 1 is on.

5. A power supply circuit portion for a converter, the power supply circuit portion having a synchronized rectifier in the output of the circuit, where the voltage across the winding that is attached to the synchronized rectifier is integrated in time during the on time of the primary switch and during the on time of the synchronized rectifier so that when the integral crosses zero determines when the synchronized rectifier turns off.

6. The power supply circuit portion of claim 5 where the threshold of the integral is modified from zero to a controlled negative value.

7. The power supply circuit portion of claim 6, configured to measure the voltage across the winding that is attached to the synchronized rectifier of claim 6 where the drain waveform of synchronized rectifier is used with a blocking capacitor to reproduce the differential voltage across the winding.

8. The power supply circuit portion of claim 8, where an additional winding is used instead of the synchronous rectifier winding to measure the integral.

9. The power supply circuit portion of claim 7, where an additional winding is used instead of the synchronous rectifier winding to measure the integral.

10. The power supply circuit portion of claim 6 where an additional winding is used instead of the synchronous rectifier winding to measure the integral.

11. The power supply circuit portion of claim 5, where an additional winding is used instead of the synchronous rectifier winding to measure the integral.

12. A power supply circuit portion, wherein the power supply circuit comprises a discontinuous mode flyback converter where peak current limit is used in the primary and the output current limit is controlled by varying the frequency of the flyback based on the output voltage or another winding that reflects the output voltage setting.
